(19) United States
(12) Patent Application Publication
(10) Pub. No.: US 2026/0264277 A1
(43) Pub. Date: Sep. 10, 2026

(54) Folding Knife with a Safety Lock

(71) Applicant: N.U.M.B. Knifeworks, Brighton, MI (US)

(72) Inventor: Nicholas Palizzi, Brighton, MI (US)

(21) Appl. No.: 19/560,283

(22) Filed: Mar. 9, 2026

Related U.S. Application Data
(60) Provisional application No. 63/768,832, filed on Mar. 7, 2025.

(51) Int. Cl. B26B 1/04

(52) U.S. Cl. CPC B26B 1/04

(57) ABSTRACT

A safety lock for a folding knife with a handle and a blade includes a first locking member and a second locking member. The first locking member extends from a first button end to a first latch end and has a first trunnion arm arranged between the first button end and the first latch end. The second locking member extends from a second button end to a second latch end and has a second trunnion arm arranged between the second button end and the second latch end. The first and second locking members are pivotable about trunnion axes defined by the respective trunnion arms. The safety lock further includes a biasing member engaged with the first locking member and the second locking member and configured to bias the first latch end and the second latch end against the blade.

### CROSS-REFERENCE TO RELATED APPLICATIONS

The subject patent application claims priority to, and all the benefits of, United States Provisional Patent Application No. 63/768,832, filed on Mar. 7, 2025, the entire contents of which are incorporated by reference herein.

### BACKGROUND

A folding knife is a knife that pivots around a hinge or a pivot point, allowing it to fold into a handle for compact storage and safe carrying. These folding knives are used for various everyday purposes such as outdoor activities, utility tasks, and self-defense. For safe use of these knives, various locking mechanisms have been developed to secure the blade in a folded position within the handle and/or in an extended position during use. However, existing locks often suffer from limitations, including accidental disengagement, insufficient locking strength and difficulty in operation. Some designs are inconvenient and difficult to operate because the locking mechanism is inconvenient to access due to its location or design. Therefore, there is a need for an improved safety lock mechanism that provides a reliable locking system and ease of operation while minimizing the risk of accidental unlocking.

### SUMMARY

In one aspect, a folding knife includes a handle including a first frame and a second frame spaced from and coupled to the first frame. The folding knife further includes a blade and a safety lock. The blade has a distal end and an opposite proximal end, wherein the blade is arranged between the first frame and the second frame and pivotable between a folded position and an extended position. The safety lock is operatively coupled to the handle and movable between a locked state and an unlocked state. The safety lock includes a first locking member and a biasing member. The first locking member extends from a first button end to a first latch end and has a first trunnion arm arranged between the first button end and the first latch end, wherein the first locking member is pivotable about a first trunnion axis defined by the first trunnion arm. The biasing member is engaged with the first locking member and configured to bias the first latch end against the blade. The first button end of the first locking member is operable to pivot the first locking member about the first trunnion axis and move the first latch end away from the blade.

In another aspect, a safety lock for a folding knife having a handle and a blade includes a first locking member and a second locking member. The first locking member extends from a first button end to a first latch end and has a first trunnion arm arranged between the first button end and the first latch end, wherein the first locking member is pivotable about a first trunnion axis defined by the first trunnion arm. The second locking member extends from a second button end to a second latch end and has a second trunnion arm arranged between the second button end and the second latch end, wherein the second locking member is pivotable about a second trunnion axis defined by the second trunnion arm. The safety lock further includes a biasing member engaged with the first locking member and the second locking member and configured to bias the first latch end and the second latch end against the blade.

Any of the above aspects can be combined in full or in part. Any features of the above aspects can be combined in full or in part. Any of the above implementations for any aspect can be combined with any other aspect. Any of the above implementations can be combined with any other implementation whether for the same aspect or a different aspect.

### BRIEF DESCRIPTION OF THE DRAWINGS

Advantages of the present disclosure will be readily appreciated as the same becomes better understood by reference to the following detailed description when considered in connection with the accompanying drawings.

FIG. 1 is a front perspective view of a first embodiment of a folding knife with a safety lock and a blade shown in an extended position.

FIG. 2 is a rear view of the folding knife and the safety lock of FIG. 1 and showing the blade in a folded position.

FIG. 3 is a front view of the folding knife and the safety lock of FIG. 1 and showing the blade in the extended position.

FIG. 4 is a top view of the folding knife of FIG. 1 with the safety lock and showing the blade in the extended position.

FIG. 5 is a fragmentary and close-up phantom view of the safety lock of FIG. 1.

FIG. 6 is a front perspective view of a folding knife with a safety lock and a blade shown in the folded position and a frame portion of the handle removed.

FIG. 7 is fragmentary and close-up phantom view of the safety lock of FIG. 6.

FIG. 8 is a side view of the frame portion of the handle showing a locking member and trunnion axis.

FIG. 9A is a rear view of the blade and the safety lock showing the locking members in a locked state.

FIG. 9B is a rear view of the blade and safety lock showing the locking members in an unlocked state.

FIG. 10 is a front perspective view of a second embodiment of a folding knife with a safety lock and a blade shown in an extended position.

FIG. 11 is a cross-sectional rear view of the folding knife and safety lock of FIG. 10 with the safety lock shown in a locked state.

FIG. 12 is a partially exploded view of the folding knife and safety lock of FIG. 10 with a left frame member removed to show the safety lock.

FIG. 13 is a side view of the frame portion of the handle showing a locking member and trunnion axis.

### DETAILED DESCRIPTION

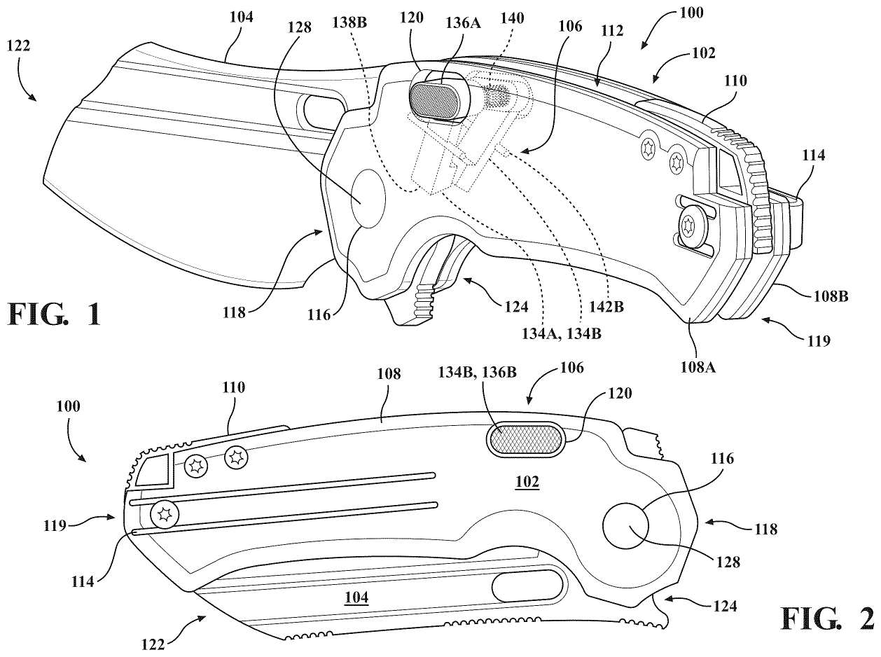

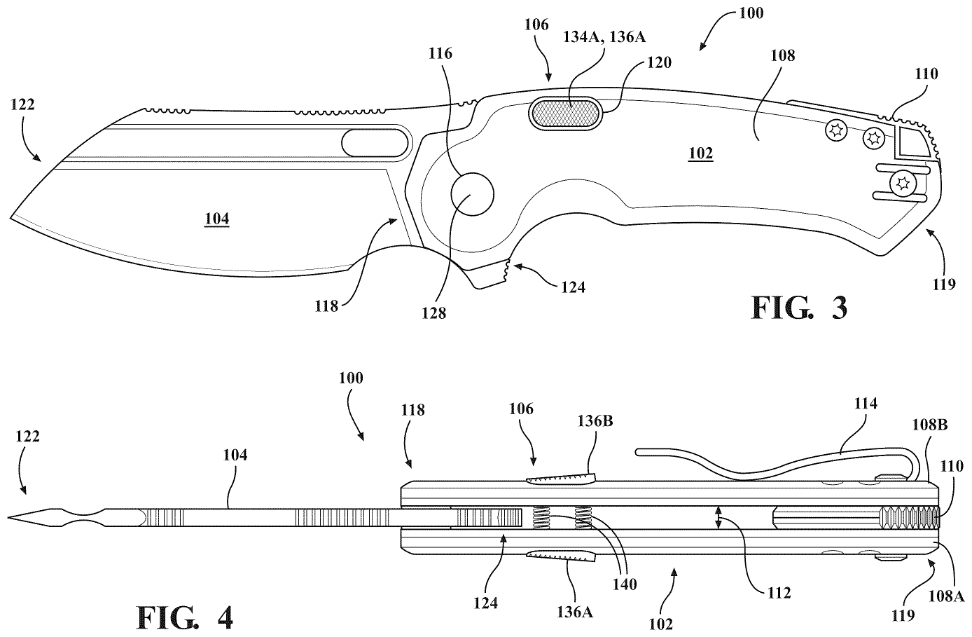

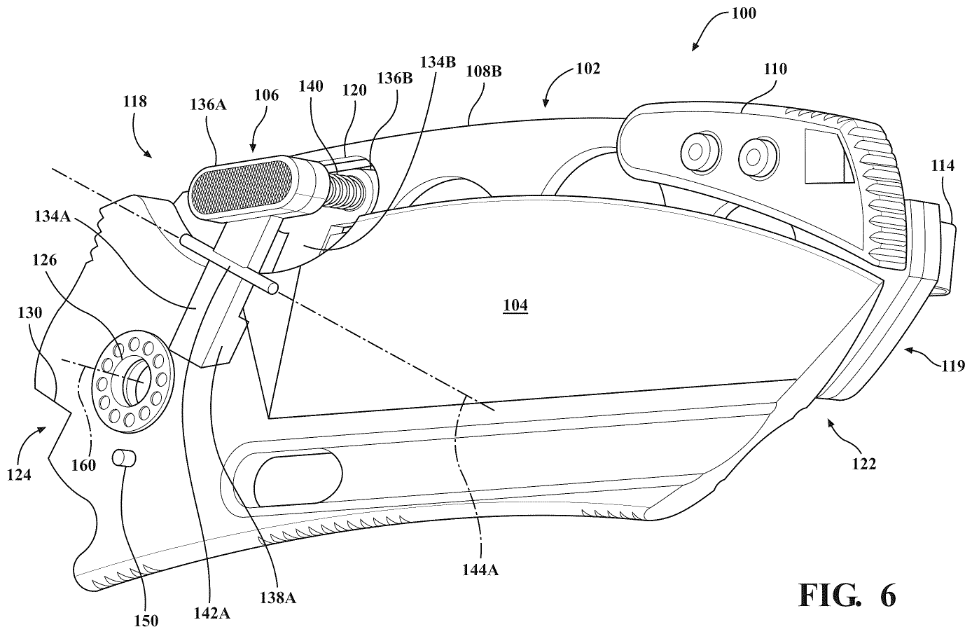

A first embodiment of a folding knife 100 with a safety lock 106 is shown in FIGS. 1-9B. As shown in FIG. 1, the folding knife 100 includes a handle 102, a blade 104, and the safety lock 106. The blade 104 is pivotably connected to the handle 102 and pivotable between an extended position (FIG. 1), where a sharpened edge of the blade 104 is exposed for cutting, and a folded position (FIG. 2), where the sharpened edge of the blade 104 is protected within the handle 102.

In FIG. 1 the folding knife 100 is shown with the safety lock 106 securing the blade 104 in the open or extended position. FIG. 2 depicts the folding knife 100 in the folded position where the safety lock 106 engages the blade 104 to retain the blade 104 in the handle 102. The safety lock 106 is operatively coupled to the handle 102 and operable by a user to selectively allow the blade 104 to pivot relative to the handle 102. A user may transition the folding knife 100 between the extended position and the folded position when the user actuates the safety lock 106 into an unlocked state.

Best shown in FIGS. 1 and 4, the handle 102 includes two spaced apart frames 108, a first frame 108A and a second frame 108A, each extending longitudinally between a blade end 118 and an opposite butt end 119. A spacer 110 is positioned between the butt end 119 of each of the frames 108A, 108B. The first frame 108A is coupled to a first side of the spacer 110 and the second frame 108B is coupled to an opposite second side of the spacer 110. A gap 112 is defined between the first frame 108A and the second frame 108B. The handle 102 may further include a pocket clip 114, shown in FIG. 4, coupled to one of the first or second frames 108A, 108B. Each of the frames 108A, 108B defines a blade support hole 116 extending through the blade end 118 and a cut-out 120 adjacent to the blade support holes 116 to support the safety lock 106, further described below.

The blade 104 extends longitudinally between a distal end 122 and a proximal end 124. The proximal end 124 of the blade 104 is pivotably coupled to the blade end 118 of the frames 108. An aperture 126 is defined in the proximal end 124 of the blade 104 and is configured to receive a connecting member 128. The connecting member 128 is inserted through the aperture 126 and the blade support holes 116 to define a pivot axis 160 and pivotably couple the blade 104 to the handle 102.

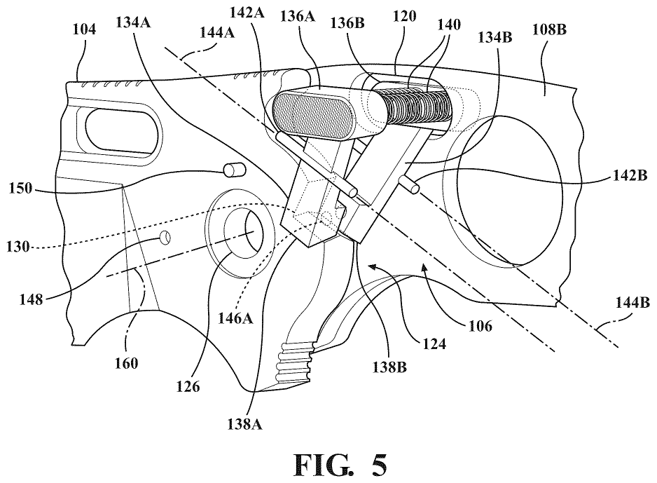

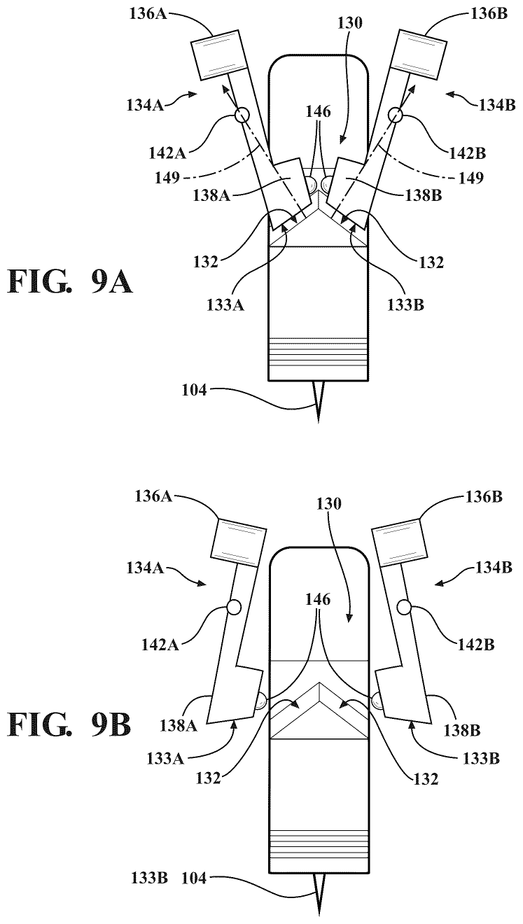

In FIGS. 5, 9A, and 9B, the blade 104 further includes a blade notch 130 formed at the proximal end 124 of the blade 104. The blade notch 130 forms a right angle cutout in the shape of the blade 104 at the proximal end 124. The blade notch 130 includes two wedge surfaces 132 angled toward one another to form a peak. The wedge surfaces 132 are engageable with the safety lock 106, as will be discussed below. The blade 104 further includes a plurality of detent ball rests 148 recessed in opposite sides of the blade 104 and arranged for engagement with the safety lock 106. In the extended position, the safety lock 106 engages the blade notch 130 and in the folded position the safety lock 106 engages the detent ball rests 148 to provide resistance to moving the blade 104 out of the folded position.

Best shown in FIG. 5, the safety lock 106 includes two locking members 134A, 134B each positioned opposite to one another and seated in the cut-out 120 of one of the frames 108A, 108B and movable between a locked state (FIGS. 1, 3-5, and 9A) and an unlocked state (FIGS. 2, 6, 7, and 9B). More specifically, a first locking member 134A is positioned in the cut-out 120 defined in the first frame 108A and a second locking member 134B is positioned in the cut-out 120 defined in the second frame 108B. Each of the first and second locking members 134A, 134B functions in a similar manner to one another and has similar geometry. As such, the first and second locking members 134A, 134B are referred to as locking members 134 when the description refers to details common to both locking members. In an alternative implementation of the safety lock, the two locking members 134A, 134B may be substituted for a single locking member that operates similarly to either one of the two locking members 134A, 134B described herein.

Each of the locking members 134 extends between a button end 136A, 136B and an opposite distal latch end 138A, 138B. More specifically, the first locking member 134A extends between a first button end 136A and a first latch end 138A and the second locking member 134B extends between a second button end 136B and a second latch end 138B. Here too, the first and second button ends 136A, 136B and the first and second latch ends 138A, 138B may be referred to generally as button ends 136 and latch ends 138. Each of the latch ends 138 includes a locking face arranged to engage one of the wedge surfaces 132 in the blade notch 130. The first latch end 138A includes a first locking face 133A and the second latch end includes a second locking face 133B. The locking faces 133A, 133B are angled toward each other to match the angle of the corresponding wedge surface 132.

Each of the locking members 134 includes a trunnion arm 142 arranged between the button end 136 and the latch end 138. More specifically, the first locking member 134A includes a first trunnion arm 142A arranged between the first button end 136A and the first latch end 138A, and the second locking member 134B includes a second trunnion arm 142B arranged between the second button end 136B and the second latch end 138B. Each of the trunnion arms 142 defines a trunnion axis 144 that does not intersect with the pivot axis 160 of the blade 104 and is angled relative to a longitudinal axis of the handle 102. A first trunnion axis 144A associated with the first locking member 134A is parallel to a second trunnion axis 144B associated with the second locking member 134B. Each of the locking members 134 pivots about the respective trunnion axis 144 while transitioning between the locked state and the unlocked state. In other words, the first locking member 134A pivots about the first trunnion axis 144A and the second locking member 134B pivots about the second trunnion axis 144B.

The safety lock 106 further includes a biasing member 140 arranged between the opposed locking members 134. In the exemplary implementation of the safety lock 106 illustrated herein, the biasing member 140 is implemented as a coiled compression spring. It should be appreciated that the biasing member 140 may be implemented as more than one coiled compression spring or as other mechanisms arranged to pivot the locking members 134 about the respective trunnion axis 144. For example, an alternative implementation of the biasing member may be arranged between the latch ends 138A, 138B of each locking member 134A, 134B and the corresponding frame 108A, 108B. A first biasing member may be arranged between the first latch end 138A and the first frame 108A to bias the first latch end 138A away from the first frame 108A and into the gap and pivot the first locking member 134A about the first trunnion axis 144A.

FIGS. 4 and 5 show two biasing members 140 arranged parallel to one another between the opposing locking members 134A, 134B. In particular, a first end of each biasing member 140 engages the first button end 136A and a second end of each biasing member 140 engages the second button end 136B such that the biasing members 140 bias the button ends 136A, 136B away from each other, which pivots the locking members 134A, 134B about the respective trunnion axis 144A, 144B and moves the latch ends 138A, 138B towards each other. The safety lock 106 may alternatively include one or more biasing members 140 between the locking members 134.

Referring to FIG. 5, each of the locking members 134 further includes one or more detent balls 146, which are coupled to the latch ends 138 of each of the locking members 134. In one implementation, only one of the locking members 134 may include the detent balls 146, while in other implementations, each locking member 134 may include more than one detent ball 146. The blade 104 further includes one or more detent ball rests 148 defined in the proximal end 124 of the blade 104 and configured to receive the detent ball 146 when the blade 104 is in the folded position to retain the blade 104 in the folded position. Each of the detent ball rests 148 engages with one of the detent balls 146 retaining the blade 104 in the folded position. The detent balls 146 are biased toward the blade 104 by the biasing member 140. The detent balls 146 may be disengaged from the detent ball rests 148 by actuating the safety lock 106 by pressing the button ends 136A, 136B towards each other to pivot the locking members 134A, 134B about the respective trunnion axes 144A, 144B and move the latch ends 138A, 138B away from each other and out of engagement with the detent balls 146. Alternatively, the blade 104 may be pivoted toward the extended position with enough force to overcome the force from the biasing member 140 and engagement pressure between the detent balls 146 and the detent ball rests 148 retaining the blade 104 in the folded position. The detent balls 146 slide on the proximal end 124 of the blade 104 while the blade 104 pivots from the folded position to the extended position. Friction between the blade 104 and the detent balls 146 resists pivoting of the blade to prevent uncontrolled motion as the blade 104 moves between the folded position and the extended position.

The safety lock 106 prevents movement of the blade 104 when the blade 104 is in the extended position and the safety lock 106 is in the locked state. Similarly, when the blade 104 is in the folded position, the safety lock 106 provides resistance to movement of the blade 104 toward the extended position. The safety lock 106 is movable by the user from the locked state to the unlocked by pressing the button ends 136A, 136B. When the safety lock 106 is in the unlocked state, shown in FIG. 9B, the locking faces 133A, 133B are disengaged from the corresponding wedge surface 132 allowing the proximal end 124 of the blade 104 to move between the latch ends 138A, 138B thereby allowing the blade 104 to be pivoted from the extended position to the folded position. In the locked state, shown in FIG. 9A, the locking faces 133A, 133B of the latch ends 138A, 138B are engaged with the wedge surfaces 132, which prevents the blade 104 from being pivoted out of the extended position. The safety lock 106 may be actuated into the unlocked state by pressing the button ends 136A, 136B toward each other, which pivots the locking members 134A, 134B about the respective trunnion axes 144A, 144B and moves the latch ends 138A, 138B away from each other, thereby disengaging the locking faces 133A, 133B from the wedge surfaces 132 of the blade notch 130.

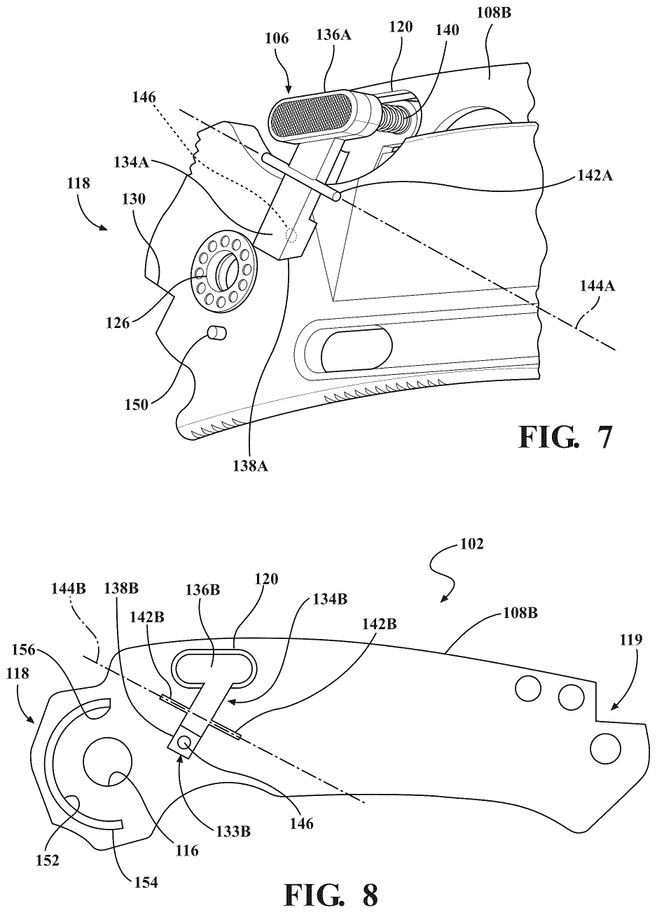

Best shown in FIGS. 7 and 8, the blade 104 may further include a blade stop 150 protruding from the proximal end 124 of the blade 104. The blade stop 150 extends in a direction generally parallel to the pivot axis 160. In the first embodiment of the folding knife 100, the blade 104 includes two blade stops 150, each protruding from the proximal end 124 on an opposite side of the blade 104. Each blade stop 150 is positioned in a slot 152, which is defined in each of the frames 108 of the handle 102. More specifically, a first blade stop 150 is positioned within a first slot 152 defined in the first frame 108A and a second blade stop 150 is positioned within a second slot 152 defined in the second frame 108B. When the blade 104 moves between the folded position and the extended position, each of the blade stops 150 traverses through the respective slot 152 and limits the rotation range of the blade 104 determined by the slots 152 defined in the frames 108. Each of the slots 152 has an arcuate shape and extends from a first slot end 154 to a second slot end 156. When the blade 104 is in the folded position, the blade stop 150 is positioned near the first slot end 154. Similarly, when the blade 104 is in the extended position, the blade stop 150 is positioned near the second slot end 156.

In the folded position, the blade 104 is recessed in the gap 112 in the handle 102. Further, in the folded position, the detent balls 146 of the locking members 134 are biased to engage with the detent ball rests 148 defined in the blade 104 to retain the blade 104 in the folded position. This retention engagement may be overcome by unlocking the safety lock 106 or by exerting force on the blade 104 to overcome the engagement. When the blade 104 transitions from the folded position to the extended position by pivoting movement of the blade 104 relative to the handle 102, the detent balls 146 slide along the outer side surface of the blade 104 creating a friction force that prevents uncontrolled motion of the blade 104.

The safety lock 106 locks the blade 104 in the extended position. Specifically, force from the biasing member 140 against the button ends 136A, 136B applies a pivoting torque to the locking members 134A, 134B about the trunnion axes 144A, 144B such that the latch ends 138A, 138B move towards each other into the blade notch 130. When the latch ends 138A, 138B are positioned in the blade notch 130 the locking faces 133A, 133B engage with the wedge surfaces 132 to block pivoting movement of the blade 104 and lock the blade 104 in the extended position. The safety lock 106 is unlocked by moving the button ends 136A, 136B towards each other, pivoting the latch ends 138A, 138B about the respective trunnion axes 144A, 144B to disengage the locking faces 133A, 133B from the wedge surfaces 132 thereby allowing the blade 104 to pivot from the extended position to the folded position. FIG. 9A shows two force lines 149 that illustrate the direction of the forces on the locking members 134A, 134B when the blade 104 is in the extended position with the safety lock 106 in the locked state and the blade 104 is pivoted toward the folded position. Because the angle of the locking faces 133A, 133B matches the angle of the wedge surfaces 132, the face-to-face engagement between the locking faces 133A, 133B and the wedge surfaces 132 transfers force perpendicular to the faces along the force lines 149. The wedge surfaces 132 are angled such that the perpendicular force is aligned with the trunnion arms 142A, 142B. Because the perpendicular force along the force lines 149 is aligned with the trunnion arms 142A, 142B a rotational force about the pivot axes 144A, 144B is not created. As a result, when a force is applied to the blade 104 that would cause the blade 104 to pivot out of the extended position, the locking members 134A, 134B do not rotate thereby locking the blade 104 in the extended position.

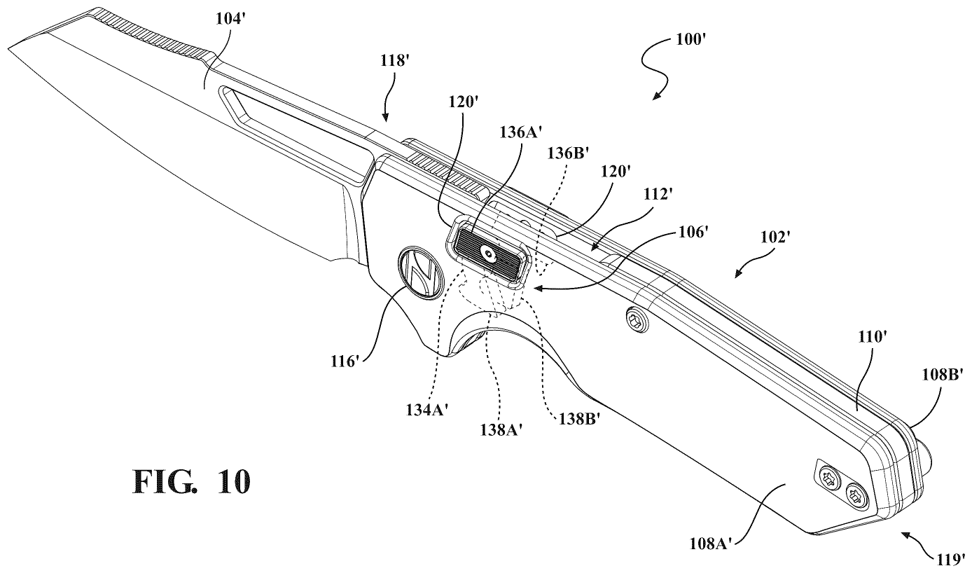

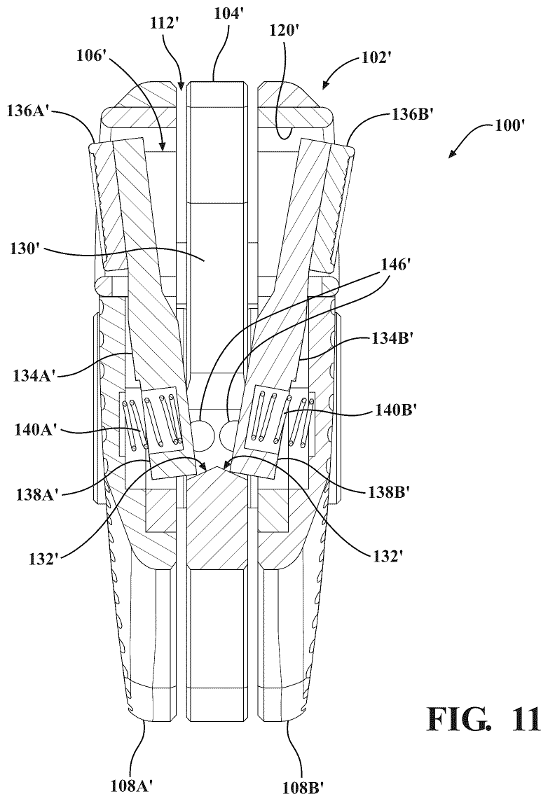

Turning to FIGS. 10-13, a second embodiment of the folding knife 100′ is shown with the blade 104′ in the extended position. As with above, the folding knife 100′ includes a handle 102′ having a first frame 108A′ and a second frame 108B′ with the blade 104′ pivotably connected to the handle 102′ between the first frame 108A′ and the second frame 108B′. Here too, the folding knife 100′ includes a second embodiment of the safety lock 106′ for securing the blade 104′ in the open position.

As will be appreciated from the subsequent description below, the second embodiment of the folding knife 100′ is similar to the first embodiment of the folding knife 100 described above in connection with FIGS. 1-9B. As such, the components and structural features of the second embodiment of the folding knife 100′ that are the same as, or that otherwise correspond to, the first embodiment of the folding knife 100′ are provided with the same reference numerals with the addition of a prime symbol (e.g., 100 and 100′). While the specific differences between these implementations will be described in detail, for the purposes of clarity, consistency, and brevity, only certain structural features and components common between these implementations will be discussed and depicted in the drawings of the second embodiment of the folding knife 100′. Here, unless otherwise indicated, the above description of the first embodiment of the folding knife 100 may be incorporated by reference with respect to the second embodiment of the folding knife 100′ without limitation.

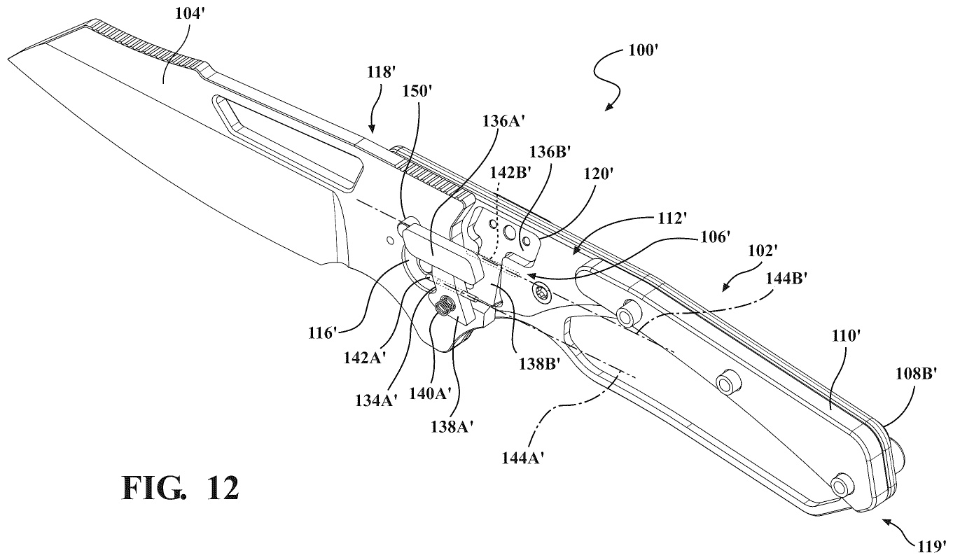

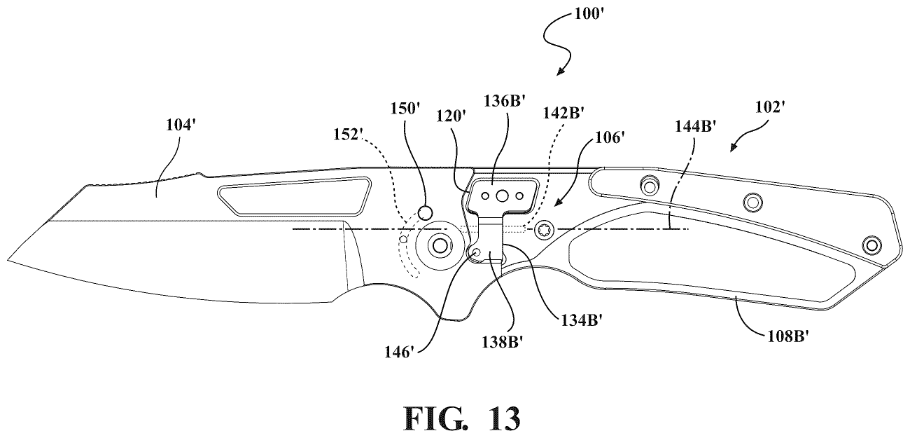

Shown in FIGS. 12 and 13, the blade 104′ includes a blade notch 130′ formed at the proximal end 124′ of the blade 104′. The blade notch 130′ includes two wedge surfaces 132′ angled toward one another to form a peak. The wedge surfaces 132′ are engageable with the safety lock 106′ when the blade 104′ is in the extended position, as will be discussed below.

Similar to the safety lock 106 described above in connection with the first embodiment of the folding knife 100′, the second embodiment of the safety lock 106′ includes two locking members 134A′, 134B′, each positioned opposite to one another and seated in the cut-out 120′ of one of the frames 108A′, 108B′. Each of the locking members 134A′, 134B′ extends between a button end 136A′, 136B′ and an opposite distal latch end 138A′, 138B′. Each of the locking members 134A′, 134B′ includes a trunnion arm 142A′, 142B′ arranged between the button end 136A′, 136B′ and the latch end 138A′, 138B′, with each of the trunnion arms 142A′, 142B′ defining a trunnion axis 144A′, 144B′. Each of the locking members 134A′, 134B′ pivots about the respective trunnion axis 144A′, 144B′ while transitioning between the locked state and the unlocked state. Each of the locking members 134A′, 134B′ further includes a detent ball 146′ coupled to the latch end 138A′, 138B′ of each of the locking members 134A′, 134B′.

The second embodiment of the safety lock 106′ further includes a biasing member 140A′, 140B′ for each of the locking members 134A′, 134B′. In this embodiment of the safety lock 106′, each of the biasing members 140A′, 140B′ is arranged between the latch end 138A′, 138B′ of each of the locking members 134A′, 134B′ and the respective frame 108A′, 108B′. Specifically, a first biasing member 140A′ is arranged between the latch end 138A′ of the first locking member 134A′ and the first frame 108A′. A second biasing member 140B′ is arranged between the latch end 138B′ of the second locking member 134B′ and the second frame 108B′.

As mentioned, the safety lock 106′ prevents movement of the blade 104′ when the blade 104′ is in the extended position and the safety lock 106′ is in the locked state. The safety lock 106′ is movable by the user from the locked state to the unlocked by pressing the button ends 136A′, 136B′. Pressing the button ends 136A′, 136B′ toward each other pivots the locking members 134A′, 134B′ about the respective trunnion axes 144A′, 144B′ and moves the latch ends 138A′, 138B′ away from each other, thereby disengaging the latch ends 138A′, 138B′ from the wedge surfaces 132′ of the blade 104′. As the locking members 134A′, 134B′ are pivoted toward the unlocked state, the latch ends 138A′, 138B′ compress the respective biasing member 140A′, 140B′. When the user releases the button ends 136A′, 136B′, the compressed biasing members 140A′, 140B′ exert a force on the latch ends 138A′, 138B′ toward the blade 104′ causing the locking members 134A′, 134B′ to pivot in the opposite direction and toward the locked state.

When the safety lock 106′ is in the locked state, the latch end 138A′, 138B′ of each of the locking members 134A′, 134B′ engage with one of the wedge surfaces 132′ to block pivoting movement of the blade 104′ and lock the blade 104′ in the extended position. Force from the blade 104′ acting on the latch ends 138A′, 138B′ is transferred in line with the locking members 134A′, 134B′ to the trunnion arms 142A′, 142B′ and does not create a pivoting torque about the trunnion axes 144A′, 144B′.

Several instances have been discussed in the foregoing description. However, the aspects discussed herein are not intended to be exhaustive or limit the disclosure to any particular form. Various modifications to these aspects will be readily apparent to those skilled in the art, and the generic principles defined herein may be applied to other aspects without departing from the scope of the disclosure. The terminology that has been used is intended to be in the nature of words of description rather than of limitation. Many modifications and variations are possible in light of the above teachings and the disclosure may be practiced otherwise than as specifically described.

What is claimed is:

1. A folding knife, comprising:
a handle comprising a first frame and a second frame spaced from and coupled to the first frame;
a blade having a distal end and an opposite proximal end, wherein the blade is arranged between the first frame and the second frame and pivotable between a folded position and an extended position;
a safety lock operatively coupled to the handle and movable between a locked state and an unlocked state, the safety lock comprising:
a first locking member extending from a first button end to a first latch end and having a first trunnion arm arranged between the first button end and the first latch end, wherein the first locking member is pivotable about a first trunnion axis defined by the first trunnion arm; and
a biasing member engaged with the first locking member and configured to bias the first latch end against the blade;
wherein the first button end of the first locking member is operable to pivot the first locking member about the first trunnion axis and move the first latch end away from the blade.

2. The folding knife of claim 1, further comprising a second locking member extending from a second button end to a second latch end and having a second trunnion arm arranged between the second button end and the second latch end, wherein the second locking member is pivotable about a second trunnion axis defined by the second trunnion arm, and wherein the second button end of the second locking member is operable to pivot the second locking member about the second trunnion axis and move the second latch end away from the blade.

3. The folding knife of claim 2, wherein the biasing member is further defined as a first biasing member and a second biasing member, and wherein the second biasing member is engaged with the second locking member and configured to bias the second latch end against the blade.

4. The folding knife of claim 3, wherein the first biasing member is arranged between the first latch end and the first frame, and wherein the second biasing member is arranged between the second latch end and the second frame.

5. The folding knife of claim 2, wherein the second trunnion axis is parallel to the first trunnion axis.

6. The folding knife of claim 2, wherein the biasing member is further defined as a coiled compression spring.

7. The folding knife of claim 2, wherein, in the locked state, the first latch end and the second latch end are pivoted towards each other to lock the blade in the extended position; and
wherein, in the unlocked state, the first latch end and the second latch end are pivoted away from each other to allow movement of the blade.

8. The folding knife of claim 2, wherein an arcuate slot is defined in the first frame and has a first slot end and a second slot end, wherein the blade includes a first blade stop arranged in the arcuate slot and movable from the first slot end to the second slot end to define the folded position and the extended position.

9. The folding knife of claim 1, wherein the blade includes an angled wedge surface arranged proximate the proximal end of the blade and wherein the first latch end engages the wedge surface when the safety lock is in the locked state to retain the blade in the extended position.

10. The folding knife of claim 9, wherein the first locking member includes a detent ball arranged on the first latch end and wherein a detent ball rest is defined in the proximal end of the blade and configured to receive the detent ball when the blade is in the folded position to retain the blade in the folded position.

11. The folding knife of claim 1, wherein an aperture is defined in the first frame and wherein the first button end of the first locking member is positioned in the aperture.

12. A safety lock for a folding knife having a handle and a blade, the safety lock comprising:
a first locking member extending from a first button end to a first latch end and having a first trunnion arm arranged between the first button end and the first latch end, wherein the first locking member is pivotable about a first trunnion axis defined by the first trunnion arm;
a second locking member extending from a second button end to a second latch end and having a second trunnion arm arranged between the second button end and the second latch end, wherein the second locking member is pivotable about a second trunnion axis defined by the second trunnion arm;
a first biasing member engaged with the first locking member and configured to bias the first latch end toward the second latch end; and
a second biasing member engaged with the second locking member and configured to bias the second latch end toward the first latch end.

13. The safety lock of claim 12, wherein the first button end of the first locking member is operable to pivot the first locking member about the first trunnion axis and move the first latch end away from the blade and the second button end of the second locking member is operable to pivot the second locking member about the second trunnion axis and move the second latch end away from the blade.

14. The safety lock of claim 12, wherein the first biasing member is arranged between the first latch end and the first frame, and wherein the second biasing member is arranged between the second latch end and the second frame.

15. The safety lock of claim 12, wherein the second trunnion axis is parallel to the first trunnion axis.

16. The safety lock of claim 12, wherein the first biasing member and the second biasing member are further defined as coiled compression springs.

17. A safety lock for a folding knife having a handle and a blade, the safety lock comprising:
a first locking member extending from a first button end to a first latch end and having a first trunnion arm arranged between the first button end and the first latch end, wherein the first locking member is pivotable about a first trunnion axis defined by the first trunnion arm;
a second locking member extending from a second button end to a second latch end and having a second trunnion arm arranged between the second button end and the second latch end, wherein the second locking member is pivotable about a second trunnion axis defined by the second trunnion arm; and
a biasing member engaged with the first locking member and the second locking member and configured to bias the first latch end and the second latch end against the blade into a locked configuration.

18. The safety lock of claim 17, wherein each of the first latch end and the second latch end has a locking face and wherein each of the locking faces is arranged to engage a wedge surface of the blade when the safety lock is in the locked configuration.

19. The safety lock of claim 17, wherein the biasing member is arranged between the first button end of the first locking member and the second button end of the second locking member.
